(19) United States
(12) Patent Application Publication
(10) Pub. No.: US 2026/0103915 A1
(43) Pub. Date: Apr. 16, 2026

(54) JAM-RESISTANT KEY CONTAINERS

(71) Applicant: Honeywell International Inc., Charlotte, NC (US)

(72) Inventor: Matthew Hill, Sublimity, OR (US)

(21) Appl. No.: 18/914,619

(22) Filed: Oct. 14, 2024

(51) Int. Cl. E05B 19/00; E05B 9/00

(52) U.S. Cl. CPC E05B 19/0005; E05B 9/00

(57) ABSTRACT

An example of a jam-resistant key container comprises a body configured to be disposed within a housing of a lockbox, the body including a first surface, a second surface, a third surface and fourth surface; a key compartment formed in a portion of the third surface, where the key compartment is configured to receive a key, a movable lid coupled to the third surface at a position adjacent to the key compartment, where the movable lid is configured to move between a first position where the movable lid covers the key compartment and a second position where the movable lid exposes the key compartment; and a mating recess formed in a portion of the fourth surface, where the mating recess includes latches that are configured to mate with components of a locking assembly of the lockbox when the jam-resistant key container is disposed in the housing of the lockbox.

### TECHNICAL FIELD

The present disclosure relates generally to lockable devices such as lockbox assemblies, and more particularly to jam-resistant key containers for use in a lockable device.

### BACKGROUND

Lockable devices such as lockbox assemblies (e.g., lockboxes) typically provide a secured storage area for a key or other access aid at a location close to a locked property accessible by the key. An authorized user can unlock the lockbox to gain access to the secured storage area and then use the key contained therein to unlock the locked property.

The lockbox may be attached to a door handle or to another stationary object, for instance, at a location that is near the traditional lock. The lockbox may require a user to demonstrate that he is authorized to obtain access to the locked property before the secured storage area is unlocked to allow the user to obtain the key. In a mechanical lockbox, the user might be required to enter a correct lock combination to access the secured storage area. In an electronic lockbox, the user might be required to communicate a credential to lockbox (via a physical connection to the lockbox or via a wireless link to the lockbox) to access the secured storage area.

### SUMMARY

The present disclosure relates to jam-resistant key containers for use in lockable devices. Traditional lockable devices such as lockboxes typically provide a secured storage area for a key or other access device at a location close to a locked property accessible by the key or other type of access device. For instance, various traditional lockboxes may be configured to be locked on a door handle (e.g., a doorknob) and permit a key container to be selectively disposed and locked therein.

However, the key containers in various traditional lockable devices may be prone to becoming inoperable (e.g., jammed). For instance, the key containers in various traditional lockable devices may become jammed when a key or other type of object (e.g., a business card) is disposed in an incorrect location within the key container and/or within another portion of the traditional lockable devices. For example, some key containers may include a relatively large key container and/or may include latches (e.g., for coupling or locking a key container within a housing of the traditional lockable devices) that are located a relatively large distance away from corresponding structures in the housing and/or in a locking assembly. The larger key container and/or large distance between the latches and the corresponding structures in the housing and/or in a locking assembly may render traditional lockable devices prone to jamming. For instance, a key may be disposed outside of the key container or may be disposed inside of the key container and may inadvertently migrate to a location outside of the key container (e.g., due to movement of traditional lockable devices, for example, when unlocking/locking such devices, etc.).

For example, the traditional keyboxes may include a retention flange or protrusion that partially obscures a volume of or an opening to the key compartment. Such retention flanges can be present to promote retention of a key within the key compartment. Yet, despite the presence of the retention flange a key located inside the key compartment may in some instances still migrate outside of the key compartment and thus may interfere with or even prohibit operation (e.g., cause jamming) of the traditional key containers. For example, the key may become lodged at an interface between the keybox and a housing of the traditional locking containers, thereby prohibiting the relative movement between the traditional keyboxes and the housing e.g., jamming the traditional locking container. In such instances, a user of the traditional lockable devices may experience difficulties or even an inability to operate the traditional lockable devices (e.g., may have an inability to access the key within the traditional lockboxes).

Moreover, the traditional lockable devices may include an additional recess that is separate from the key container. Unlike the key container, which is the intended location for placement of the key, the separate recess may be present for purposes of mating or coupling the key container (e.g., the latches of the key container) to corresponding structures in the housing of the traditional lockable devices. For example, some traditional key containers may include a relatively large mating recess having a large volume (e.g., with at least height, width, and/or depth that is of sufficient size to permit insertion of a key (e.g., a door key) or other type of object (e.g., a business card) therein. Thus, the key or other type may be inadvertently or incorrectly disposed with a volume of the reactively large mating recess. In such instances, a key or other type of object may interfere with, or even prohibit operation of the traditional lockboxes. For instance, a key or other type of object is present within the relatively large mating recess of the traditional key containers disposing the key container may cause the lockbox to “jam” or cease of move in a manner suitable to permit access to the key container and/or may prohibit the key container for being locked within an internal volume of the lockbox assembly.

As such, the present disclosure is directed to jam-resistant key containers, as detailed herein. For instance, the jam-resistant key containers herein may include a dedicated key compartment that is configured (e.g., is sized and shaped) to receive a key. In some embodiments, the jam-resistant key containers may include a movable lid (e.g., that is rotatable about a hinge) to selectively expose or entirely cover the compartment thereby permitting insertion of the key into the compartment (e.g., when the cover is in an open position) and promoting retention of the key within the compartment (e.g., when the cover is in a closed position). In some embodiments, the jam-resistant key container herein can include a mating recess that is relatively smaller and/or includes latches which are located closer to a locking assembly (e.g., locking mechanism) in a housing such that the mating recess does not permit a key to potentially be disposed therein (e.g., does not permit a key to be inadvertently disposed within the mating recess instead of the dedicated key compartment).

At least due to the presence of the dedicated key compartment, the movable lid, and a mating recess being smaller and/or including latches which are located closer to a locking assembly disposed within a body of a lockbox, the jam-resistant key containers can mitigate a possibility of the lockbox assemblies herein experiencing jamming, and thus can provide a substantially improved experience for an end user (e.g., making secure storage and retrieval of keys more intuitive and convenient). Moreover, mitigating the possibility of jamming can reduce a quantity of lockboxes that returned to a manufacturer of the lockbox (e.g., due to becoming jammed and thus becoming inoperable), thereby reducing any costs or difficulties associated with jammed lockboxes from the perspective of the manufacturer of the lockboxes.

An example may be found in a jam-resistant key container comprising: a body configured to be disposed within a housing of a lockbox, the body including a first surface, a second surface, a third surface and fourth surface, wherein the second surface is opposite the first surface and the fourth surface is opposite the third surface; a key compartment formed in a portion of the third surface, wherein the key compartment is configured to receive a key; a movable lid coupled to the third surface at a position adjacent to the key compartment, wherein the movable lid is configured to move between a first position where the movable lid covers the key compartment and a second position where the movable lid exposes the key compartment; and a mating recess formed in a portion of the fourth surface, wherein the mating recess includes latches that are configured to mate with components of a locking assembly of the lockbox when the jam-resistant key container is disposed in the housing of the lockbox.

Another example is found in a lockbox assembly comprising: a jam-resistant key container including: a body configured to be disposed within a housing of a lockbox, the body including a first surface, a second surface, a third surface and fourth surface, wherein the second surface is opposite the first surface and the fourth surface is opposite the third surface; a key compartment configured to receive a key; a movable lid coupled to the third surface at a position adjacent to the key compartment, wherein the movable lid is configured to move between a first position where the movable lid covers the key compartment and a second position where the movable lid exposes the key compartment; and a mating recess formed in a portion of the fourth surface, wherein the mating recess includes latches that are configured to mate with components of a locking assembly of the lockbox when the jam-resistant key container is disposed in the housing of the lockbox; and the housing including a first end, a second end opposite the first end, an internal cavity located between the first end and the second end, wherein the internal cavity is configured to receive the jam-resistant key container and permit the jam-resistant key container to translate relative to the body.

Yet another example is found in a lockbox assembly comprising: a jam-resistant key container including: a body configured to be disposed within a housing of a lockbox, the body having a profile that is complementary to a profile of the lockbox and including a first surface, a second surface, a third surface and fourth surface, wherein the second surface is opposite the first surface and the fourth surface is opposite the third surface; a key compartment formed in a portion of the third surface, wherein the key compartment is configured to receive a key; a movable lid coupled to the third surface at a position adjacent to the cavity, wherein the movable lid is configured to move between a first position where the movable lid covers the key compartment and a second position where the movable lid exposes the key compartment; and a mating recess formed in a portion of the fourth surface, wherein the mating recess includes latches that are configured to mate with components of a locking assembly of the lockbox when the jam-resistant key container is disposed in the housing of the lockbox; and the housing including a first end, a second end opposite the first end, an internal cavity located between the first end and the second end, wherein the internal cavity is configured to receive the jam-resistant key container and permit the jam-resistant key container to translate relative to the body; and the locking assembly comprising at least one locking module for selectively locking the jam-resistant key container within the housing.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1A is a perspective view of an example of a lockable assembly including a jam-resistant key container, the lockable assembly being configured in a closed configuration;

FIG. 1B is a view of an example of a lockable assembly including a jam-resistant key container, the lockable assembly being configured in an open configuration;

FIG. 1C is a perspective view of an example of a lockable assembly having a jam-resistant key container (e.g., a key box) in a closed position;

FIG. 1D is an exploded view of the example of the lockable device having the jam-resistant key container of FIGS. 1A-1C;

FIG. 2A is a perspective view of an example of a jam-resistant key container in a closed configuration;

FIG. 2B is a perspective view of an example of a jam-resistant key container in an open configuration;

FIG. 2C is another perspective view of an example of a jam-resistant key container in a closed configuration; and

FIG. 3 is a view of an example of a locking assembly in accordance with some embodiments of the disclosure.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranged by endpoints includes all numbers subsumed within that range (e.g., 1 to 5 includes, 1, 1.5, 2, 2.75, 3, 3.8, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

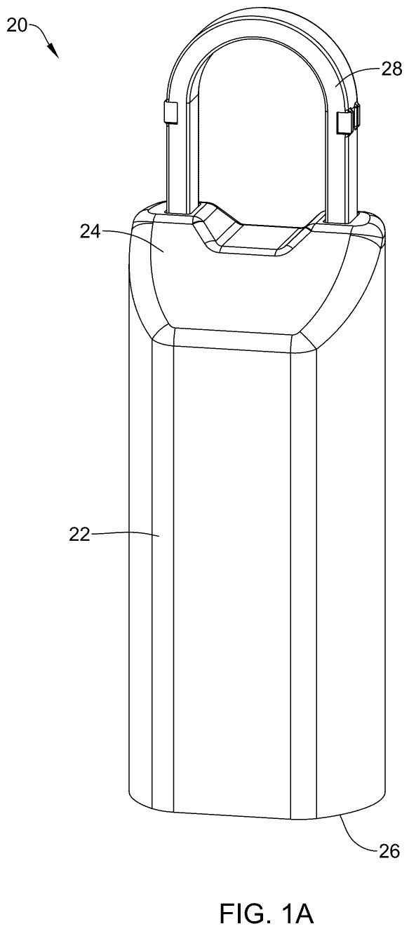

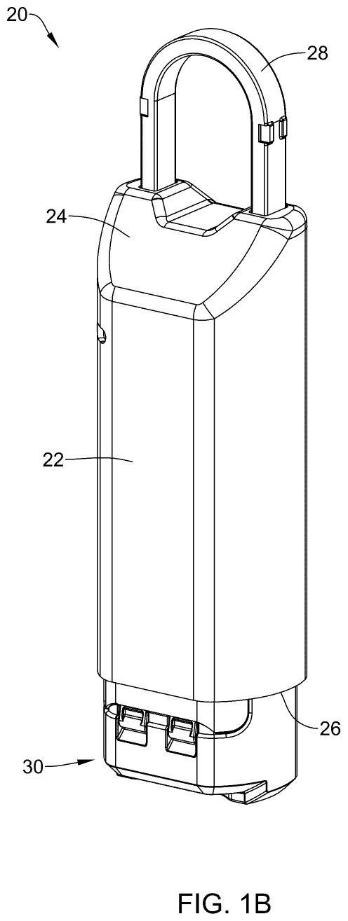

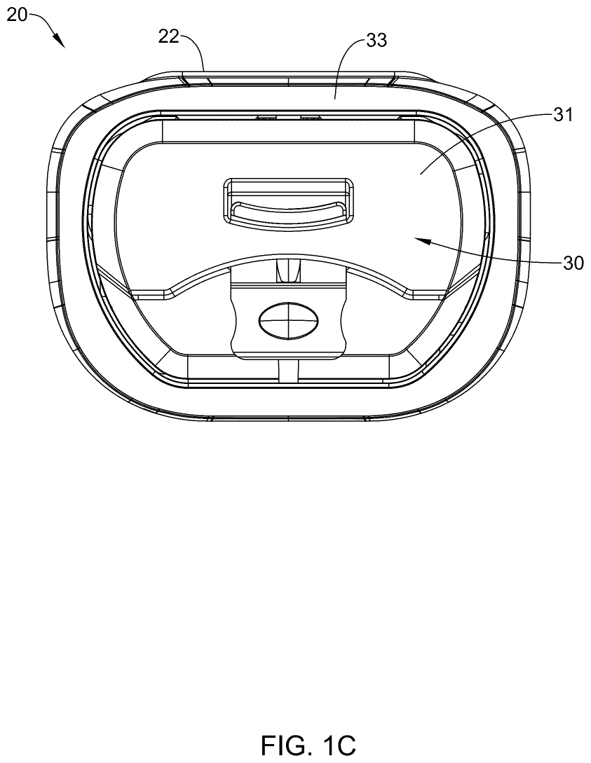

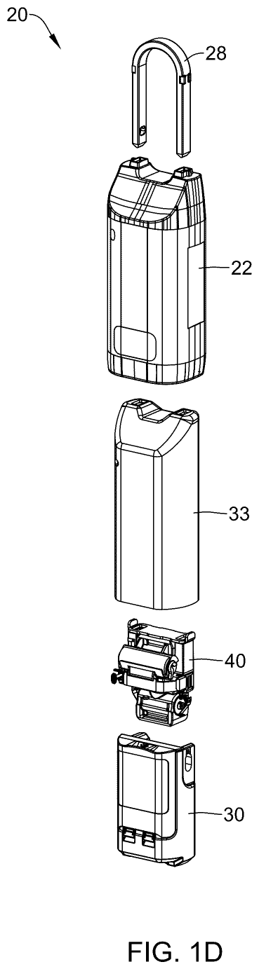

Referring now to FIGS. 1A-1D, an example of a lockable assembly 20, such as a lockbox is illustrated. FIG. 1A is a perspective view of an example of a lockable assembly 20, such as a lockbox, in a closed configuration, FIG. 1B is a view of the example of a lockable assembly 20 including a jam-resistant key container 30 in an open configuration, and FIG. 1C is a view (e.g., bottom view) of the lockbox assembly 20 with a jam-resistant key container 30 in a closed position (e.g., as depicted in FIG. 1A). The lockbox assembly 20 includes a body 22 with a first end 24 and a second, opposite end 26. A shackle 28 is positioned adjacent to the first end 24 of the body 22. The body 22 is configured to house a jam-resistant key container (not visible in this view) within its internal cavity. For example, the lockbox assembly 20 includes a shackle 28 positioned adjacent to a first end 24 of the body 22 and a jam-resistant key container 30 positioned adjacent to a second, opposite end 26 of the body 22.

When in the closed configuration, the jam-resistant key container 30 can be disposed within the internal cavity of the housing 33 that is located within the body 22 of the lockbox assembly 20. That is, the jam-resistant key container 30 can have a body 31 that is configured to be disposed within a housing 33 of the lockbox assembly 20. For instance, the body 31 of the jam-resistant key container 30 can have a profile that is complementary with a profile of the housing 33 of the lockable assembly 20. This way, the jam-resistant key container 30 can fit tightly within the housing 33 of the lockable assembly 20. For example, the jam-resistant key container 30 can be configured to be disposed entirely within the internal cavity of the housing 33. For instance, the jam-resistant key container 30 can be recessed a distance from the second end 26 of the body 22 when disposed in the internal cavity of the housing 33. Having the keybox be recessed a distance from the second end 26 of the body of 22 when disposed in the internal cavity of the housing (e.g., in the closed configuration) can promote aspect herein such as mitigating an ability to tamper with the jam-resistant key container 30.

The shackle 28 may be configured to translate and/or rotate relative to the body 22. Alternatively, or in addition, the jam-resistant key container 30 may be configured to translate relative to the body 22. In an embodiment, at least one of the shackle 28 and the jam-resistant key container 30 is separable from the body 22. In an embodiment, at least the jam-resistant key container 30 is separable from the body 22 (e.g., is separable from the housing 33 of the body 22).

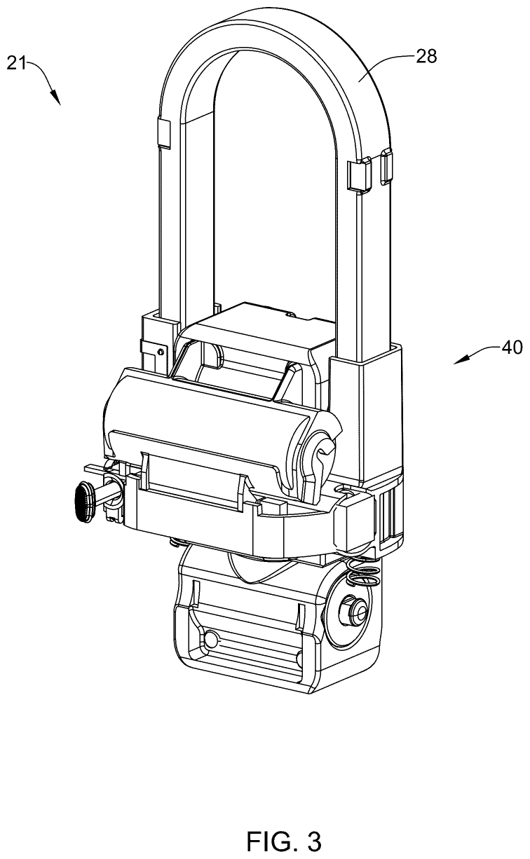

FIG. 1D is an exploded view of the example of the lockbox assembly 20 having the jam-resistant key container 30 of FIGS. 1A-1C. As illustrated in the FIG. 1D, the lockable device can include various components such as shackle (e.g., shackle 68 or shackle 69) which is analogous or similar to the shackle 28, a body 22, a housing 33 which is disposed and coupled to (e.g., permanently coupled to the body 22 via mounting hardware (not illustrated) or otherwise coupled to the body 22), a locking assembly 40, as described herein (e.g., with respect to FIG. 3), and the jam-resistant key container 30. The lockbox assembly 20 can include additional elements such as mounting hardware, gaskets, etc. For instance, the lockbox assembly 20 can include additional elements described with respect to described in U.S. Pat. No. 11,428,026, the entire contents of which are herein incorporated by reference.

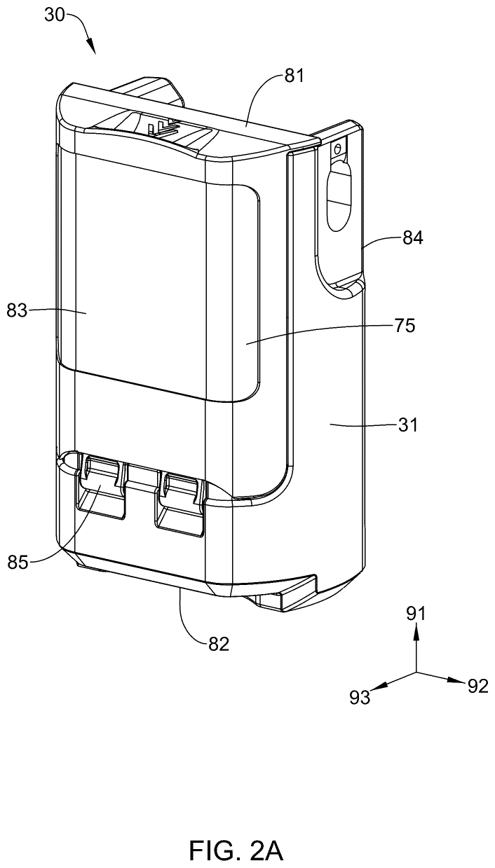

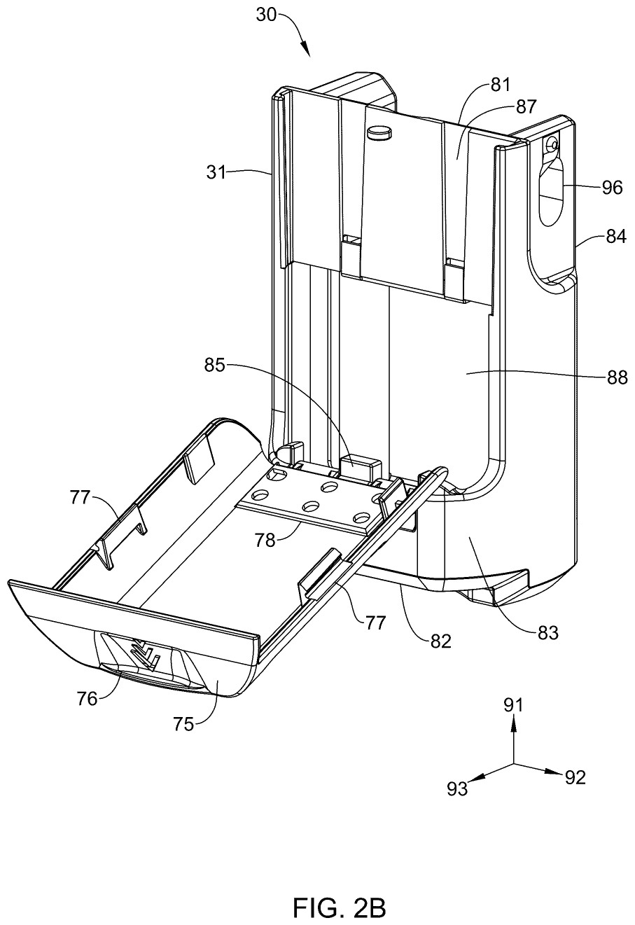

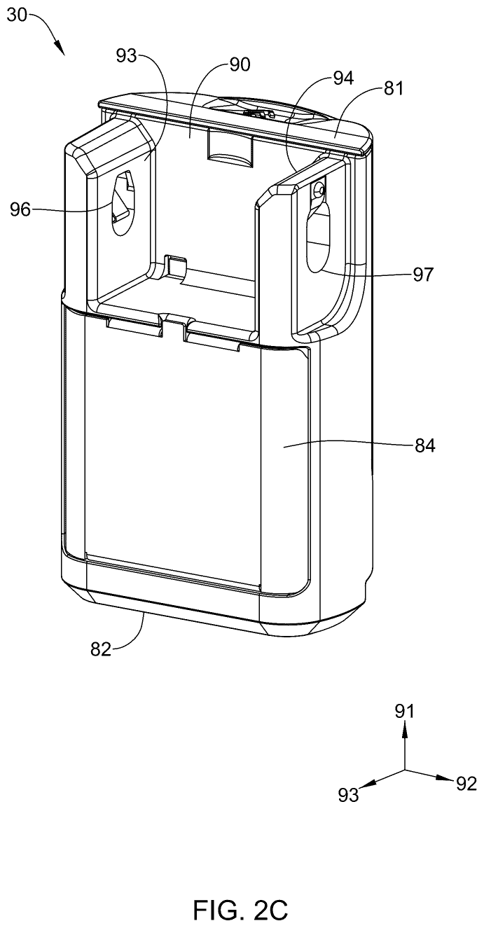

FIG. 2A is a perspective view of an example of a jam-resistant key container 30 in a closed configuration, while FIG. 2B is a perspective view of an example of a jam-resistant key container 30 in an open configuration. That is, the jam-resistant key container 30 can include a lid 75 that is configured to move (e.g., rotate) relative a body 31 of the jam-resistant key container 30 thereby permitting the keybox to be selectively configured in a closed configuration and an open configuration, as described herein.

The lid 75 can include a grooved or otherwise textured surface element 76 that is configured to indicate a direction of opening (e.g., with one or more chevrons or an arrow, etc.). of the lid 75 and provide a textured surface to permit the lid 75 to readily be opened (e.g., when contacted by a user). The lid 75 can include one or more clips 77 (e.g., clip 77 as illustrated in FIG. 2B) configured to mechanically retain (e.g., provide a holding force) to maintain the lid in the first position where the movable lid covers the key compartment, and yet also permit the lid 75 to be moved to the second position where the movable lid exposes the key compartment. The lid 75 can include a substantially planar component (e.g., a rubber component or plastic component) configured to abut the hinge 85 when the lid 75 is in the second position.

The body 31 of the jam-resistant key container 30 includes a first surface 81 (e.g., top surface), a second surface 82 (e.g., bottom surface) opposite the first surface 81, a third surface 83 (e.g., a front surface), and a fourth surface 84 (e.g., a back surface) opposite the third surface 83, as described herein. The first surface 81, the second surface 82, the third surface 83, and the fourth surface 84 can together form the continuous body 31 of the jam-resistant key container 30, as illustrated in FIGS. 2A-2C. For instance, the first surface 81, the second surface 82, the third surface 83, and the fourth surface 84 can together form continuous exterior surface of the body 31. Stated differently, in some embodiments, the body 31 of the jam-resistant key container 30 can be a continuous uniform body formed including at least the first surface 81, the second surface 82, the third surface 83, and the fourth surface 84. For instance, the body 31 can be formed of a molded material such as an injection molded material (e.g., plastic), among other possibilities.

A key compartment 88 can be formed in a portion of the body 31. For instance, a key compartment 88 can be formed in a portion of the third surface 83, as illustrated in FIG. 2B. Stated differently, the key compartment 88 can be formed by a portion of a surface such as the third surface 83 that is recessed relative to another portion of the third surface 83.

The key compartment 88 can be configured to receive a key. For instance, the key compartment 88 can be sized and shaped to receive a key. In some embodiments, the key compartment 88 can be manifested as an uninterrupted volume that is recessed as distance within a portion of a surface such as the third surface 83, as illustrated in FIG. 2B. In some embodiments, the key compartment 88 can have an uninterrupted internal volume, the mating recess, as described herein, can have an uninterrupted volume, or both the key compartment 88 and the mating recess can have respective uninterrupted volumes. Having an uninterrupted volume (e.g., without any intervening integral components being located within or projecting substantially into a volume of the key compartment 88 can promote aspects herein such as permitting a key or other object to be readily disposed in and retrieved from the key compartment 88. The key compartment 88 can have a height (e.g., taken along a first axis 91), a width (e.g., taken along a second axis 92), and a depth or length (e.g., taken along a third axis 93). For example, the key compartment can have a height, a width, and a length that are each less than a longest dimension of a typical sized key (e.g., is less than about 55 millimeters or is less than about 50 millimeters) such as a typical door key (e.g., a door key to a house, apartment, condominium, etc.).

In some embodiments, on a surface of the jam-resistant key container 30 (which could be the third (e.g., front) surface) has a cavity 87 which includes the key compartment 88, as illustrated in FIG. 2B. The cavity 87 can be recessed a first distance (e.g., along the third axis 93) in the surface (e.g., the third surface 83) and the key compartment 88 can be recessed a second distance in the surface. For instance, the second distance can be larger than the first distance. Stated differently, the portion of the cavity 87 that forms the key compartment 88 can have a depth (e.g., along the third axis 93) that is greater than a depth of the remainder of the cavity 87 which is located adjacent to the key compartment 88.

Adjacent to this key compartment 88, is the movable lid 75. For instance, the movable lid coupled to the third surface at a position adjacent to the key compartment 88. That is, the movable lid can be coupled to the same surface (e.g., the third surface 83) in which the key compartment 88 is formed.

The movable lid 75 can move (e.g., rotate) relative to the body 31 of the jam-resistant key container 30. The movable lid 75 can be configured to move between a first position (e.g., as illustrated in FIG. 2A) where the movable lid 75 covers the key compartment 88 and a second position (e.g., as illustrated in FIG. 2B) where the lid 75 exposes the key compartment 88.

For instance, the movable lid 75 can be manifested as solid continuous movable lid that is configured to overlay and thereby cover the entire key compartment 88 when the movable lid 75 is configured in the first position. Yet, the movable lid 75 when in the first position can remain spaced a distance away from at least an innermost surface of the key compartment 88 to permit a key to be present in the key compartment 88. Stated differently, when the movable lid 75 is in the first position, the movable lid 75 can overlay (e.g., entirely block and obscure) the key compartment 88 such that a key cannot be inserted or retrieved from the key compartment 88, but permit a key to be present within the key compartment 88 (e.g., when the lid 75 is in the first position).

However, when the movable lid 75 is in the second position, the movable lid 75 can expose the key compartment 88 such that the key can be readily inserted and/or retrieved from the key compartment 88. Thus, the movable lid 75 can securely retain a key within the key compartment when in the first position, yet can permit the key to be readily accessed (e.g., retrieved from) the key compartment 88. Hence, the movable lid 75 is designed to move between a first position covering at least the key compartment 88 and the cavity 87 and a second position at which the movable lid 75 exposes the key compartment 88 and the cavity 87.

For instance, the movable lid 75 may be configured to rotate about a hinge 85 to selectively expose (e.g., when in the second position) or entirely cover (e.g., when in the first position) the key compartment 88. For example, the movable lid 75 can be configured to selectively rotate about the hinge 85 (e.g., responsive to contact of a portion of the movable lid 75 such as the textured surface element 76 by a user) between the first (e.g., closed) position and the second (e.g., open) position, and yet can be configured to remain in the first position when the jam-resistant key container 30 is disposed within an internal cavity of the housing of the lockbox assembly.

In some embodiments, the hinge 85 can be a rubber hinge that is formed entirely of rubber. Use of a rubber hinge which is entirely formed of rubber can promote aspects herein such as mitigating a possibility of the hinge 85 breaking and/or becoming dislodged from the body 31 (e.g., responsive to a user of the lockbox assembly accidently dropping the lockbox assembly 20 and/or the jam-resistant key container 30, thus ensuring that the jam-resistant key container 30 and lockbox assembly 20 function as intended.

The jam-resistant key container 30 can include a mating recess 90. For instance, a surface of the body 31 can include a mating recess 90. In some embodiments, the mating recess 90 can be located on a surface that is opposite from a surface in which the key compartment is located. That is, the mating recess 90 can be separate (e.g., is without an opening in the body 31 interlinking the respective volume thereof) from the key compartment. For instance, the mating recess 90 can be located on the fourth surface 84 (e.g., back surface) of the jam-resistant key container (jam-resistant key container 30), as illustrated in FIG. 2C, while the key compartment 88 can be located on the third surface 83, as illustrated in FIG. 2B.

Notably, the mating recess 90 can be relatively small and/or can include latches which are located closer or more proximate to a locking assembly (e.g., the locking assembly 40 as illustrated in FIG. 3) as compared to other traditional structures. Having the mating recess 90 be relatively small and/or include latches that are more proximate to a locking assembly can promote aspects herein such as ensuring that the mating recess 90 does not permit a key to potentially be disposed therein (e.g., does not permit a key be inadvertently disposed within the mating recess 90 instead of the dedicated key compartment 88).

The mating recess 90 can be located proximal to the first surface 81 of the body 31, as illustrated in FIG. 2C. For example, a portion of the volume of the mating recess 90 can be extend between opposing portions of the first surface 81. Stated differently, the mating recess 90 can be a recess formed at least partially within the first surface 81, the fourth surface 84, or both the first surface 81 and the fourth surface 84. For example, the mating recess 90 can be a manifested as a substantially rectangular U-shaped mating recess located between sidewalls of the body 31, as illustrated in FIG. 2C. Thus, the mating recess 90 can be located within a portion of the first surface 81 and located within an upper portion of the fourth surface 84. That is, the mating recess 90 can extend within an upper portion of the fourth surface 84 from the first surface 81 along a portion of a height of the key container 30.

Notably and unlike other traditional structures such as those described herein, the mating recess 90 does not extend into a lower portion (e.g., a lower half or portion of the fourth surface 84 that is more distally located relative to the first surface 81 than the location of the mating recess 90 depicted in FIG. 2C) of the fourth surface 84. Thus, mating recess 90 can be relatively small at least in part due to being located in an upper portion of the fourth surface 84.

As mentioned, the relatively small size of the mating recess 90 ensures that a key or other similarly sized object (e.g., a business card) will not fit within the mating recess 90. Hence, the mating recess 90 the mating recess is configured to not permit a key to be inserted (e.g., entirely inserted) within a volume of the mating recess, thereby preventing misuse and/or jamming that results from misplacement of a key. For example, the mating recess 90 can have a height, a width, and a length that are each less than a longest dimension of a typical sized key (e.g., is less than about 55 millimeters or is less than about 50 millimeters).

The mating recess 90 can include a plurality of latches including a first latch 96 and a second latch 97. In some embodiments, each of the plurality of latches such as the first latch 96 and the second latch 97 can be the same shape and size. In some embodiments, each of the plurality of latches such as the first latch 96 and the second latch 97 is located at the same respective location (e.g., disposed substantially at a center thereof) on opposing interior surfaces 93, 94 of the mating recess 85. In some embodiments, the first latch 96 and the second latch 97 are located at the same respective location on the opposing interior surfaces 93, 94 of the mating recess 85, and wherein the first latch and the second latch are the same size and the same shape, as illustrated in FIG. 2C.

Unlike the latch configurations in some traditional lockboxes, the first latch 96 and the second latch 97 can be located more proximate to the first surface 81 of the body 31 of the jam-resistant key container 30 than the second surface 82 of the body 31 of the jam-resistant key container 30. Similarly, the first latch 96 and the second latch 97 can be located more proximate to the first end 24 of the body 22 than a second end of the body 22 of the lockbox assembly 20 (e.g., when the jam-resistant key container 30 is disposed within the internal cavity of the housing 33 of the lockbox assembly 20). Having the latch be more proximate to the first surface 81 of the body 31 than the second surface 82 of the body 31 can promote aspects herein such as reducing a size of the mating recess 85 and/or otherwise mitigating a potential for jamming of the jam-resistant key container within the lockbox assembly 20.

The portion of the lockbox assembly 21 includes a locking assembly (e.g., represented by element 40 in FIG. 3). An example of a suitable locking assembly is described in U.S. Pat. No. 11,428,026, the entire contents of which are herein incorporated by reference. For instance, the locking assembly 40 is operable to selectively couple a first component and a second component. In an embodiment, when applied to a lockable device, such as lockbox assembly 20 (e.g., the portion of the lockbox assembly 21 as illustrated in FIG. 1D), the locking assembly 40 selectively locks the shackle 28 to the body (e.g., body 22 as illustrated in FIG. 1D). Accordingly, the locking assembly 40 restricts movement of the lockbox assembly 20 once arranged in a desired location via the shackle 28. Alternatively or in addition, the locking assembly 40 may be used to selectively lock the jam-resistant key container to the body. In such instances, operation of the locking assembly 40 may provide an authorized user with access to the internal cavity of the jam-resistant key container, within which one or more items, such as a key for example, may be stored.

In some embodiments, the locking assembly 40 can be configured to selectively couple at least one of the shackle 28 and the jam-resistant key container to the body of the lockbox assembly. The locking assembly 40 can include at a first locking module (not illustrated), associated with the shackle 28 and a second locking module (not illustrated) associated with the jam-resistant key container. However, embodiments including only a single locking module are also contemplated herein. The locking module includes a generally hollow housing and a rotatable shaft is receivable within an opening formed in the exterior surface of the housing.

In such embodiments, the shaft is oriented substantially perpendicular to the longitudinal axis of the housing. However embodiments where the shaft and the housing have another orientation are within the scope of the disclosure. Located within the hollow interior of the housing is a retaining member through which the shaft extends. The retaining member is aligned with and/or coupled to a spacer arranged within the hollow interior of the housing, generally adjacent to a corresponding end thereof. A passage extends from the end of the housing, through the spacer and the retaining member.

A locking element, such as a plunger for example, is movably mounted within this passage and a biasing mechanism is mounted concentrically with the locking element. A biasing force of the biasing mechanism is configured to bias the locking element away from the shaft, towards a locked position. In an embodiment, the locking element is formed from or includes any suitable magnetic material. In some embodiments, a suitable magnetic material includes a composite magnetic material, or alternatively, may include a non-magnetic material having a separate magnetic component or material attached to a portion thereof.

An opening corresponding to a portion of each locking element is formed in a portion of the shaft. The shaft is rotatable rotated between a first position and a second position to control movement of the locking plunger. When the shaft is in the first position, the opening is not aligned with a corresponding passage. As a result, the locking plunger is blocked from moving towards the shaft and out of engagement with a corresponding portion of either the jam-resistant key container 30, or the shackle. When the shaft is in the second position, the opening and the passage are aligned, such that the locking plunger can translate to a position engaged with the shaft. In this position, the locking plunger does not restrict movement of the jam-resistant key container, or the shackle 28.

The shaft is configured to rotate about its axis in response to operation of a mechanism, illustrated schematically at, operably coupled thereto. The mechanism for rotating the shaft may be mechanically operated by a user, or alternatively, may include an electromechanical mechanism, such as a motor, solenoid, or a piezoelectric device for example, directly or indirectly coupled to the shaft. In such embodiments, the mechanism may be operable in response to an electrical input, such as generated by a code entered via a key pad or upon detection of an identification device, such as an RFID tag for example, or communication with a second device, such as a user's mobile device or smartphone, having acceptable credentials.

In operation, a user provides an input to operate the mechanism associated with shaft. In response to the input, the mechanism drives rotation of the shaft about its axis between a first position and a second position. In the second position, the opening is aligned with a corresponding passage. Arranged within the interior of the shaft, adjacent the opening, is a permanent magnet, illustrated schematically at. In an embodiment, when the opening and a corresponding passage are aligned, the magnetic force of the permanent magnet acts on the locking plunger causing the locking plunger to translate against the biasing force of the biasing mechanism. This magnetic force causes the plunger to move from a locked position, where a portion of the locking plunger is arranged within the path of movement of the shackle 28 or jam-resistant key container relative to the body, to an unlocked position, to a position out of engagement with the shackle 28 or jam-resistant key container such that the shackle or jam-resistant key container is freely movable relative to the locking module and the body.

In an alternative embodiment, the interior of the jam-resistant key container is formed with a ramp surface positioned generally adjacent to a corresponding plunger. After authentication and rotation of the shaft about its axis to the second position, a force is applied to the jam-resistant key container. As the jam-resistant key container 30 moves in response to the force, the ramp surface engages an end of the plunger, causing the plunger to move towards the shaft. In the illustrated, non-limiting embodiment, the ramp surface is designed to apply a normal force to the plunger. However, other configurations of the ramp surface are also contemplated herein. To reconnect the shackle 28 or jam-resistant key container to the body, the mechanism is operated to rotate the shaft back to a first position. As the openings move out of alignment with the passages, the magnetic force acting on the locking plungers is reduced. As a result, the biasing force of the biasing mechanism biases the locking plungers through the passage to the locked position.

In another embodiment of the locking module, a magnet is coupled to or embedded within a portion of each locking plunger adjacent the shaft. The magnets are configured to cooperate with the magnet within the shaft to move the locking plungers in and out of engagement with a corresponding component, such as the jam-resistant key container 30 for example.

To operate the latch and decouple the components, a user provides an input to operate the mechanism associated with shaft. In response to the input, the locking element drives rotation of the shaft about its axis to an open position where the openings are aligned with a corresponding passage. In this open position, the poles of the magnet positioned within the shaft are opposite the poles of the adjacent magnets associated with the locking plungers. As the locking plungers move toward the shaft, the attraction between the magnets holds the locking plunger against the biasing force of the biasing mechanism, and within opening. Upon removal of the jam-resistant key container, the shaft is rotated to a position where the openings are misaligned with the locking plungers.

To reconnect the couple to the body via the locking module, the shaft is again rotated about its axis to a position where the openings and the locking plungers are aligned. However, during insertion of the jam-resistant key container, the poles of the magnet are substantially identical to the poles of the adjacent magnets of the locking plungers. As the jam-resistant key container is reinstalled, the force applied by the ramp surface to the locking plungers causes the locking plungers to translate within the passage towards the shaft, opposite the biasing force. As a result of the relative positioning of the magnets when the locking plungers are within proximity to the shaft, the magnets will repel. Further, the biasing force of the biasing mechanism will bias the locking plungers through the passage to the locked position to restrict movement of the jam-resistant key container relative to the body.

Each locking module of the locking assembly may be associated with a separate mechanism. Alternatively, in an embodiment a single mechanism may be used to operate multiple locking modules of a locking assembly. Depending on the configuration of the shafts, the locking modules may be operated either simultaneously or independently. For example, in embodiments where the locking modules are operated independently, operation of the mechanism in a first direction may drive the shaft associated with a first locking module between the first position and the second position, and operation of the mechanism in a second, opposite direction may drive the shaft associated with a second locking module. Alternatively, a single shaft may be used to operate the plurality of locking modules. For example, the configurations of a magnet embedded within each end of the shaft may be opposite, such that when the locking plungers of one of the locking modules is attracted to the shaft, the locking plungers of another locking module is repelled away from the shaft.

The locking module illustrated and described herein has a simplified configuration resulting in a reduced cost. Further, the compact design of the locking module eliminates the space required within the body. In addition, the locking assembly is energy efficient by requiring limited movement to lock and unlock the locking assembly.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A jam-resistant key container comprising:
a body configured to be disposed within a housing of a lockbox, the body including a first surface, a second surface, a third surface and fourth surface, wherein the second surface is opposite the first surface and the fourth surface is opposite the third surface;
a key compartment formed in a portion of the third surface, wherein the key compartment is configured to receive a key;
a movable lid coupled to the third surface at a position adjacent to the key compartment, wherein the movable lid is configured to move between a first position where the movable lid covers the key compartment and a second position where the movable lid exposes the key compartment; and
a mating recess formed in a portion of the fourth surface, wherein the mating recess includes latches that are configured to mate with components of a locking assembly of the lockbox when the jam-resistant key container is disposed in the housing of the lockbox.

2. The jam-resistant key container of claim 1, wherein the mating recess is located proximal to the first surface of the body.

3. The jam-resistant key container of claim 1, wherein the mating recess extends within an upper portion of the fourth surface from the first surface along a portion of a height of the key container.

4. The jam-resistant key container of claim 1, wherein the mating recess is a substantially rectangular U-shaped mating recess.

5. The jam-resistant key container of claim 4, wherein the latches are comprised of a plurality of latches including a first latch and a second latch.

6. The jam-resistant key container of claim 5, wherein each of the plurality of latches is located more proximate to the first surface of the body of the jam-resistant key container than the second surface of the body of the jam-resistant key container.

7. The jam-resistant key container of claim 5, wherein the first latch and the second latch are located on opposing interior surfaces of the mating recess.

8. The jam-resistant key container of claim 7, wherein the first latch and the second latch are located at the same respective location on the opposing interior surfaces of the mating recess, and wherein the first latch and the second latch are the same size and the same shape.

9. The jam-resistant key container of claim 1, wherein the mating recess is separate from the key compartment.

10. The jam-resistant key container of claim 1, further comprising a cavity formed in a portion of the third surface, wherein the cavity includes the key compartment.

11. The jam-resistant key container of claim 9, wherein the key compartment has a depth that is greater than a depth of the remainder of the cavity.

12. The jam-resistant key container of claim 1, wherein the key compartment has an uninterrupted internal volume, wherein the mating recess an uninterrupted volume, or both the key compartment and the mating recess have respective uninterrupted volumes.

13. The jam-resistant key container of claim 1, wherein the movable lid is solid continuous movable lid that is configured to cover the entire key compartment when in the first position.

14. The jam-resistant key container of claim 1, wherein the movable lid is configured to rotate about a hinge between the first position and the second position.

15. The jam-resistant key container of claim 14, wherein the hinge is a rubber hinge.

16. A lockbox assembly, comprising:
a jam-resistant key container including:
a body configured to be disposed within a housing of a lockbox, the body including a first surface, a second surface, a third surface and fourth surface, wherein the second surface is opposite the first surface and the fourth surface is opposite the third surface;
a key compartment configured to receive a key;
a movable lid coupled to the third surface at a position adjacent to the key compartment, wherein the movable lid is configured to move between a first position where the movable lid covers the key compartment and a second position where the movable lid exposes the key compartment; and
a mating recess formed in a portion of the fourth surface, wherein:
the mating recess is located proximal to the first surface of the body; and
the mating recess includes latches that are configured to mate with components of a locking assembly of the lockbox when the jam-resistant key container is disposed in the housing of the lockbox; and
the housing including a first end, a second end opposite the first end, an internal cavity located between the first end and the second end, wherein the internal cavity is configured to receive the jam-resistant key container and permit the jam-resistant key container to translate relative to the body.

17. The lockbox assembly of claim 16, wherein the jam-resistant key container is configured to be disposed entirely within the internal cavity.

18. The lockbox assembly of claim 16, further comprising a locking assembly configured to selectively lock the jam-resistant key container within the housing.

19. A lockbox assembly, comprising:
a jam-resistant key container including:
a body configured to be disposed within a housing of a lockbox, the body having a profile that is complementary to a profile of the lockbox and including a first surface, a second surface, a third surface and fourth surface, wherein the second surface is opposite the first surface and the fourth surface is opposite the third surface;
a key compartment formed in a portion of the third surface, wherein the key compartment is configured to receive a key;
a movable lid coupled, via a hinge, to the third surface at a position adjacent to the cavity, wherein the movable lid is configured to rotate between a first position where the movable lid covers the key compartment and a second position where the movable lid exposes the key compartment; and
a mating recess formed in a portion of the fourth surface, wherein:
the mating recess is located proximal to the first surface of the body; and
the mating recess includes latches that are configured to mate with components of a locking assembly of the lockbox when the jam-resistant key container is disposed in the housing of the lockbox; and
the housing including a first end, a second end opposite the first end, an internal cavity located between the first end and the second end, wherein the internal cavity is configured to receive the jam-resistant key container and permit the jam-resistant key container to translate relative to the body; and
the locking assembly comprising at least one locking module for selectively locking the jam-resistant key container within the housing.

20. The lockbox assembly of claim 19, wherein the jam-resistant key container is configured to be recessed a distance from second end of the housing when the jam-resistant key container is disposed in the internal cavity of the housing.
